(19) United States
(12) Patent Application Publication
(10) Pub. No.: US 2007/0278829 A1
(43) Pub. Date: Dec. 6, 2007

(54) ELECTRONICS SPLASH SHIELD

(75) Inventors: Oliver A. Bell, Aiken, SC (US); Aric Singletary, Hephzibah, GA (US); Michael J. Hebert, Evans, GA (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/421,860

(22) Filed: Jun. 2, 2006

(51) Int. Cl. B60J 7/00

(52) U.S. Cl. 296/193.11

(57) ABSTRACT

A protection system for at least one electrical component of a light-weight utility vehicle is provided. The system comprises a hood having a top panel and a side panel. The top panel can be connected to an interior side of at least one wall of a vehicle body structure. The side panel extends substantially perpendicularly from an edge of the top panel and can be connected to a top side of a vehicle floor structure.

### FIELD

The present disclosure relates generally to light-weight utility vehicles and a protection system for protecting at least one electrical component of the vehicle from being splashed by liquid contaminates.

### BACKGROUND

The statements in this section merely provide background information related to the present disclosure and may not constitute prior art.

Known light-weight utility vehicles, such as maintenance vehicles, shuttle vehicles and golf cars, often include one or more electrical components and/or modules that are susceptible to being splashed or contacted by corrosive or damaging liquids such as water, mud or liquefied chemicals. For example, washing and cleaning the vehicle and various vehicle parts can subject or expose the electrical components to being splashed or sprayed by the water and any other contaminate that may get mixed with the water during washing. Splashing or spraying the components with water and other liquefied contaminates can cause damage and/or corrosion to the electrical components and/or their connections.

### SUMMARY

A protection system for at least one electrical component of a light-weight utility vehicle is provided. The system includes a hood having a top panel and a side panel. The top panel can be connected to an interior side of at least one wall of a vehicle body structure. The side panel extends substantially perpendicularly from an edge of the top panel and can be connected to a top side of a vehicle floor structure.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a light-weight utility vehicle including an electrical component protection system, in accordance with various embodiments of the present disclosure;

FIG. 2 is an isometric view of the protection system shown in FIG. 1;

FIG. 3 is an isometric view of the protection system substantially covering an electronic module and including at least one electrical component mounted thereto; and

FIG. 4 is an isometric view illustrating the protection system mounted within an interior compartment of a rear body structure of the utility vehicle.

### DETAILED DESCRIPTION

The following description is merely exemplary in nature and is in no way intended to limit the present teachings, application, or uses. Throughout this specification, like reference numerals will be used to refer to like elements.

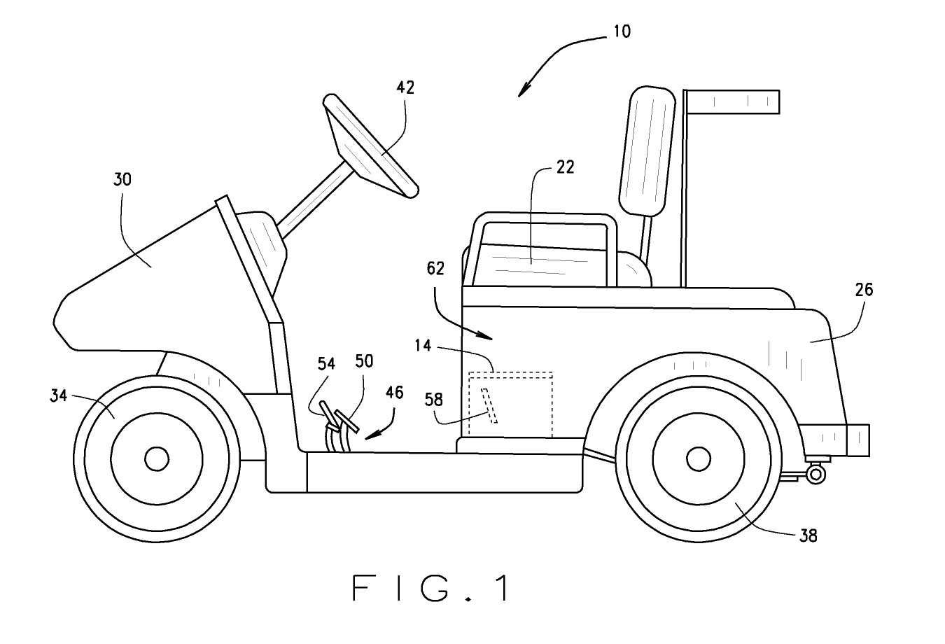

FIG. 1 illustrates a light-weight utility vehicle 10, such as a small cargo/maintenance vehicle, a shuttle vehicle or a golf car, that includes an electrical component protection system 14, in accordance with various embodiments of the present invention. The vehicle 10 also generally includes a seat assembly 22 mounted to a rear body structure 26, a front body structure 30 and a pair of front wheels 34 that operate to steer the vehicle 10. Additionally, the vehicle 10 generally includes a pair of rear wheels 38, wherein at least one of the rear wheels 38 functions as a drive wheel for propelling vehicle 10. The vehicle 10 further generally includes a steering wheel 42 controlling a steering angle of the front wheels 34 and a pedal box assembly 46 including a brake pedal subassembly 50 and an accelerator pedal subassembly 54.

The protection system 14 can be utilized for protecting at least one electrical component or electronic module 58 from being splashed or contacted by corrosive or damaging liquids such as water, mud or liquefied chemicals. For example, the electrical component 58 can be a main controller module of the vehicle 10 mounted within an interior cavity or compartment of vehicle body structure such as the rear or front body structures 26 and 30. Although the vehicle 10 can include a plurality of body structures that are suitable for housing the protection system 14 and the one or more components 58 protected by the protections system 14 within a cavity or compartment of the body structure, for simplicity and clarity, the present disclosure will be described herein with reference to only the rear body structure 26 and a battery compartment 62 of the rear body structure 26.

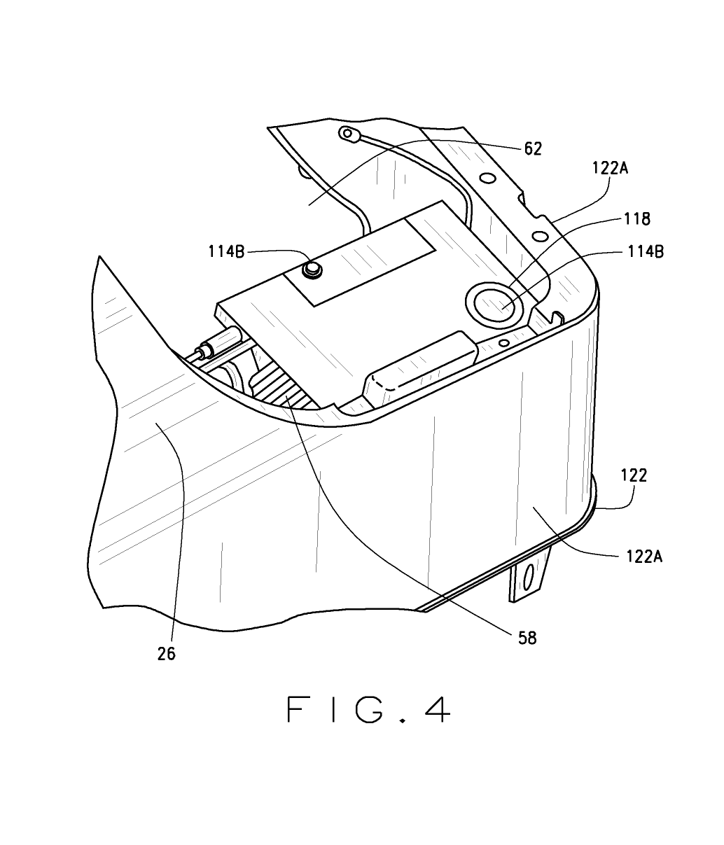

As exemplarily illustrated in FIGS. 1 and 4, the electrical component 58, e.g., the main controller module, can be mounted within an interior of the battery compartment 62. The battery compartment 62 also generally houses one or more power cells or batteries (not shown). The seat assembly 22 can be removeably or hingedly mounted to the rear body structure 26 and cover an access opening in the top of the battery compartment 62. It can be desirable to wash the exterior of the vehicles and also spray the inside of various compartments, such as the battery compartment, using sprayed or pressurized water. As described in detail below, the protection system 14 is mounted within the battery compartment 62 to substantially cover the electrical component 58. Thus, the protection system 14 protects the electrical component 58 from direct and indirect exposure to splashed or sprayed water or other liquefied contaminates, e.g., contaminates or chemicals that may get mixed with the water during washing, that can cause damage and/or corrosion to the electrical components and their connections.

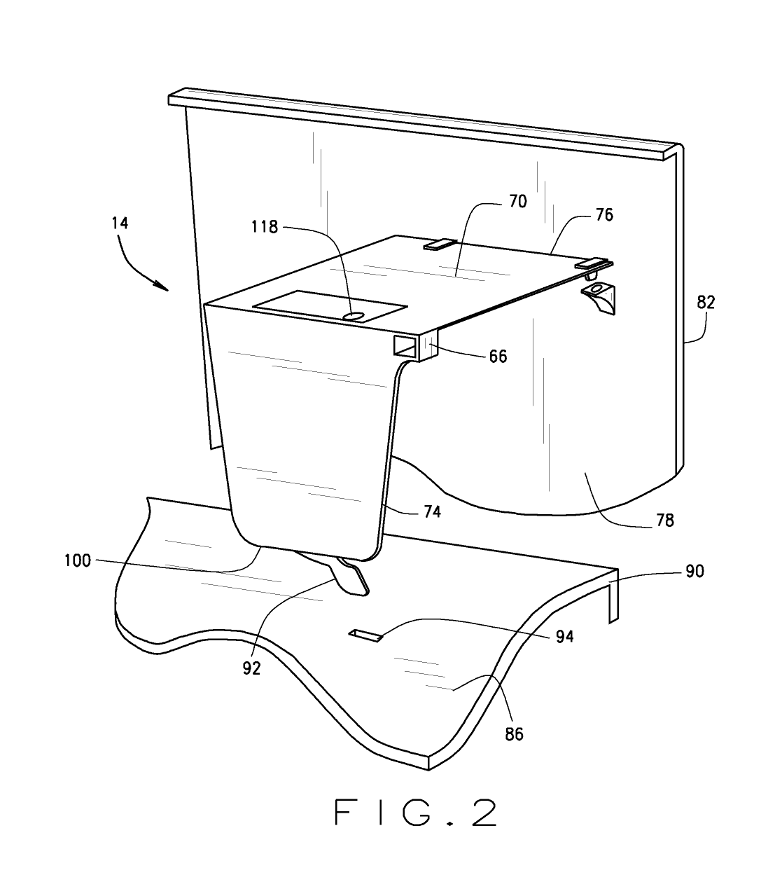

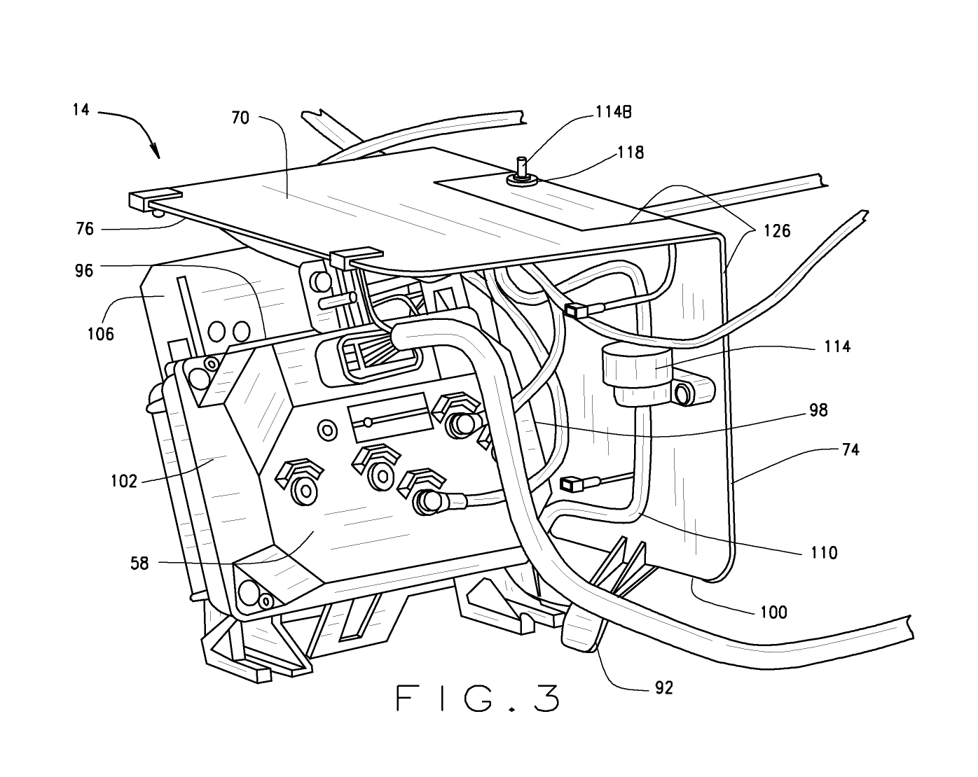

Referring to FIGS. 2 and 3, the protection system 14 includes a hood 66 having top panel 70 and a side panel 74. The top panel 70 can be connectable at a distal edge 76 to an interior side 78 of at least one wall 82 of a vehicle body structure, e.g., the rear body structure 26. The side panel 74 extends substantially perpendicularly from a top panel 70 and can be connectable to a top side 86 of a vehicle floor structure 90. In various embodiments, the side panel 74 includes a mounting tab 92 extending from a distal edge 100 for connecting or fastening the side panel 74 to a vehicle floor structure 90. In some implementations, the mounting tab 92 comprises a tongue insertable into a slot 94 in the floor structure 90 to connect the side panel 74 to the floor structure 90.

When mounted within the compartment or cavity, e.g., battery compartment 62, of the body structure, e.g., the rear body structure 26, the top panel 70 substantially covers a top 96 of the electrical component or electronic module 58, e.g., a main controller, and the side panel 74 substantially covers a first side 98 of the module. Thus, when installed, the top panel 70 protects the top 96 of the component 58 and the side panel 74 protects the first side 98 of the component 58. Additionally, when the hood 66 is installed with the distal edge 76 of the top panel 70 coupled to an interior side of the vehicle body structure wall, as described above, the body structure wall substantially covers a second side 102 of the module 58, opposite the first side 98.

Referring particularly to FIG. 3, in various embodiments the protections system 14 further includes a mounting plate 106 to which the electronic module 58 can be mounted. The mounting plate 106 can be coupled or fastened to the floor structure 90 and substantially covers a back side of the electrical component or electronic module 58.

Referring now to FIGS. 2 and 3, in various embodiments, the protection system 14 further includes an electrical harness 110 including one or more electrical device(s) 114 pre-mounted to an interior side of the top and/or side panel(s) 70 and 74. That is, the harness 110 and electrical device(s) 114 are fastened to the hood 66 prior to installation into the body structure cavity or compartment 62. For example, the harness 110 and electrical device(s) 114 can be fastened to the hood 66 during a manufacturing process of the hood 66. Thus, the hood 66, harness 110 and electrical device 114 would be pre-assembled to comprise the protection system, or in various embodiments comprise a single component of the protection system 14. The electrical device(s) 114 can be any vehicle electrical device(s) such as a horn, a backup buzzer, or a solenoid. Accordingly, the protection system 14 can also provide protection for the electrical device(s) 114 from being splashed or contacted by corrosive or damaging liquids such as water, mud or liquefied chemicals.

Referring to FIGS. 2, 3 and 4, in some embodiments, the protections system 14 can include at least one electrical device 114B mounted within an aperture 118 of the top and/or side panel(s) 70 and/or 74. The electrical device 114B can be included in the electrical harness 110 or can be an independent device mounted within the aperture 118. Accordingly, the electrical device 114B is accessible from an exterior side of the top and/or side panel(s) 70 and/or 74. For example, the electrical device 114B can be a switch accessible and operable from the exterior side of the top and/or side panel(s) 70 and/or 74, or a mileage or run-time meter accessible and viewable from the exterior side of the top and/or side panel(s) 70 and/or 74.

Referring now to FIG. 4, in various implementations the hood 66 can be adapted to couple or fasten to the vehicle body structure 26 within a corner 122 of the body structure 26. More particularly, the hood 66 can be coupled or fastened within the corner 122 such that a common edge 126 of the top and side panels 70 and 74 is adjacent a first corner wall 122A of the body structure 26. Additionally, the top panel 70 can be coupled or fastened along the distal edge 76 to a second corner wall 122B that substantially orthogonally adjoins the first corner wall 122A. In some embodiments, the top and/or side panel(s) 70 and/or 74 can be connected to a first corner wall 122A along the common edge 126. Thus, when the hood 66 is installed within the corner 122, the first corner wall 122A will substantially cover a front side 130 of the module and the second corner wall will substantially cover the second side 102 of the module 58.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A protection system for at least one electrical component of a light-weight utility vehicle, said system comprising a hood having a top panel and a side panel, the top panel connectable to an interior side of at least one wall of a vehicle body structure, the side panel extending substantially perpendicularly from a top panel and connectable to a top side of a vehicle floor structure.

2. The system of claim 1, wherein the system further comprises an electrical harness including at least one electrical component mounted to one of an interior side of the top panel and an interior side of the side panel.

3. The system of claim 1, wherein the side panel comprises a mounting tab extending from a distal edge for connecting the side panel to the floor structure.

4. The system of claim 3, wherein the mounting tab comprises a tongue insertable into a slot in the floor structure to connect the side panel to the floor structure.

5. The system of claim 1, wherein the system further comprises at least one electrical device mounted within an aperture of the top panel to be accessible from an exterior side of the top panel.

6. The system of claim 1, wherein the system further comprises at least one electrical device mounted within an aperture of the side panel to be accessible from an exterior side of the side panel.

7. The system of claim 1, wherein the hood is configured to be connectable to the body structure within a corner of the body structure such that a first corner wall is adjacent a common edge of the top and side panels and a second corner wall, substantially orthogonal to the first corner wall, is adjacent a distal edge of the top panel.

8. A protection system for an electronic module of a light-weight utility vehicle to protect the module from being splashed by liquid contaminates, said system comprising:
a hood comprising:
a top panel for substantially covering a top of the module, and
a side panel orthogonally adjoining the top panel and for substantially covering a first side of the module; and
a mounting plate for mounting the module thereto and for substantially covering a back side of the module.

9. The system of claim 8, wherein the top panel is configured to be connectable at a distal edge to an interior side of a wall of a vehicle body structure such that the wall substantially covers a second side of the module.

10. The system of claim 8, wherein the hood is configured to be connectable to a vehicle body structure within a corner of the body structure such that a first corner wall is adjacent a common edge of the top and side panels and a second corner wall, substantially orthogonally adjoining the first corner wall, is adjacent a distal edge of the top panel such that the first corner wall substantially covers a front side of the module and the second corner wall substantially covers a second side of the module.

11. The system of claim 8, wherein the system further comprises an electrical harness including at least one electrical component mounted to one of an interior side of the top panel and an interior side of the side panel.

12. The system of claim 8, wherein the side panel comprises a mounting tab extending from a distal edge for connecting the side panel to a vehicle floor structure.

13. The system of claim 12, wherein the mounting tab comprises a tongue insertable into a slot in the floor structure to connect the side panel to the floor structure.

14. The system of claim 8, wherein the system further comprises at least one electrical device mounted within an aperture of the top panel to be accessible from an exterior side of the top panel.

15. The system of claim 8, wherein the system further comprises at least one electrical device mounted within an aperture of the side panel to be accessible from an exterior side of the side panel.

16. A light-weight utility vehicle comprising:
a protection system for protecting an electronic module of the vehicle from being splashed by liquid contaminates, said system comprising:
a hood comprising:
a top panel for substantially covering a top of the module, and
a side panel orthogonally adjoining the top panel and for substantially covering a first side of the module; and
an electrical harness including at least one electrical component mounted to one of an interior side of the top panel and an interior side of the side panel.

17. The vehicle of claim 16, wherein the hood is configured to be connectable to a vehicle body structure within a corner of the body structure such that a first corner wall is adjacent a common edge of the top and side panels and substantially covers a front side of the module, and a second corner wall, substantially orthogonally adjoining the first corner wall, is adjacent a distal edge of the top panel and substantially covers a second side of the module.

18. The vehicle of claim 16, wherein the system further comprises a mounting plate for mounting the module thereto, the mounting plate substantially covering a back side of the module.

19. The vehicle of claim 16, wherein the side panel comprises a tongue insertable into a slot in a vehicle floor structure to connect the side panel to the floor structure.

20. The vehicle of claim 16, wherein the system further comprises at least one of:
at least one electrical device mounted within an aperture of the top panel to be accessible from an exterior side of the top panel; and
at least one electrical device mounted within an aperture of the side panel to be accessible from an exterior side of the side panel.
